(19) United States
(12) Patent Application Publication
(10) Pub. No.: US 2018/0121896 A1
(43) Pub. Date: May 3, 2018

(54) APPARATUS AND METHOD FOR SELF-CHECKOUT AND PAYMENT

(71) Applicant: MasterCard International Incorporated, Purchase, NY (US)

(72) Inventor: Santosh Sitaram Potadar, Pune (IN)

(21) Appl. No.: 15/783,447

(22) Filed: Oct. 13, 2017

(30) Foreign Application Priority Data
Nov. 1, 2016 (SG) 10201609114Y

(51) Int. Cl. G06Q 20/18; G06Q 20/20; G06K 7/10; G06K 7/14; G06Q 20/36

(52) U.S. Cl. CPC G06Q 20/18; G06Q 20/209; G06Q 20/36; G06K 7/1413; G06K 7/1417; G06K 7/10366

(57) ABSTRACT

There is provided a method and apparatus for self-checkout and payment. The method includes, in one or more electronic processing devices: pairing a user device with a self-checkout apparatus; capturing, at the self-checkout apparatus, a signal containing information for at least one product; extracting, at the self-checkout apparatus, the information for at least one product; receiving, from a retailer server, a payment quantum based on the information; receiving, at the self-checkout apparatus, first instructions to make payment to a retailer using a payment system; and initiating, at the payment system, the payment to the retailer. The apparatus can facilitate the method.

### CROSS REFERENCE TO RELATED APPLICATION

This application is a U.S. National Stage filing under 35 U.S.C. § 119, based on and claiming benefit of and priority to SG Patent Application No. 10201609114Y filed Nov. 1, 2016.

### FIELD OF THE INVENTION

The present invention relates to an apparatus and method for self-checkout and payment.

### BACKGROUND

Currently, payment for goods and services at physical stores/outlets typically take place at point-of-sale (POS) terminals, which may be manned by a person, or may be a do-it-yourself (DIY) terminal.

During peak periods, there are typically prolonged delays for consumers when making payment due to limited numbers of POS terminals. In nearly all circumstances, queues of consumers form at the POS terminals, leading to the delays and correspondingly, frustration and annoyance for the consumers. In some circumstances, it may even lead to boycotts of the physical stores/outlets by the consumers due to the inconvenience and unpleasantness experienced by the consumers.

This is undesirable as the physical stores/outlets lose business and correspondingly, a number of transactions at the POS terminals is also reduced.

### SUMMARY

In a first aspect, there is provided a method for self-checkout and payment, the method including, in one or more electronic processing devices: pairing a user device with a self-checkout apparatus; capturing, at the self-checkout apparatus, a signal containing information for at least one product; extracting, at the self-checkout apparatus, the information for at least one product; receiving, from a retailer server, a payment quantum based on the information; receiving, at the self-checkout apparatus, first instructions to make payment to a retailer using a payment system; and initiating, at the payment system, the payment to the retailer.

There is also provided an apparatus for self-checkout and payment, the apparatus including one or more electronic processing devices that: pairs a user device with the apparatus; captures, with an image capture apparatus/RFID receiver, a signal containing information for at least one product; extracts the information for at least one product; receives, from a retailer server, a payment quantum based on the information; receives, from the user device, first instructions to make payment to a retailer using a payment system; and transmitting, to the payment system, initiation instructions for making payment to the retainer.

Furthermore, there is also provided a non-transitory computer readable storage medium embodying thereon a program of computer readable instructions which, when executed by one or more processors of an apparatus for self-checkout and payment in communication with at least one other server, cause the apparatus to perform self-checkout and payment, the method embodying the steps of: pairing a user device with the apparatus; capturing, with an image capture apparatus/RFID receiver, a signal containing information for at least one product; extracting the information for at least one product; receiving, from a retailer server, a payment quantum based on the information; receiving, from the user device, first instructions to make payment to a retailer using a payment system; and transmitting, to the payment system, initiation instructions for making payment to the retainer.

Finally, there is also provided a non-transitory computer readable storage medium embodying thereon a program of computer readable instructions which, when executed by one or more processors of a user device in communication with an apparatus for self-checkout and payment, cause the user device to perform self-checkout and payment, the method embodying the steps of: pairing the user device with the self-checkout apparatus; receiving, from the self-checkout apparatus, the information for at least one product; and receiving, from the self-checkout apparatus, instructions to generate a receipt at the user device.

### BRIEF DESCRIPTION OF THE DRAWINGS

A non-limiting example of the present invention will now be described with reference to the accompanying drawings, in which:

FIG. 1 is a flow chart of an example of a method for self-checkout and payment;

FIG. 2 is a schematic diagram of an example of an apparatus for self-checkout and payment;

FIG. 3 is a schematic diagram of an example of a system for self-checkout and payment;

FIG. 4 is a schematic diagram showing components of an example user device of the system shown in FIG. 3;

FIG. 5 is a schematic diagram showing components of an example payment processing device of the system shown in FIG. 3; and

FIGS. 6A and 6B are flowcharts of a specific example of a method for self-checkout and payment.

### DETAILED DESCRIPTION

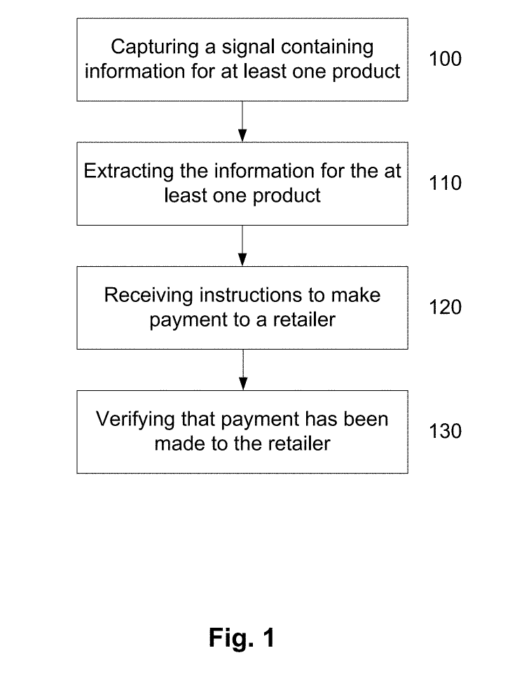

An example of a method for self-checkout and payment for at least one product will now be described with reference to FIG. 1. It should be appreciated that at least one product can also include a service.

For the purpose of illustration, it is assumed that the method is performed at least in part using one or more electronic processing devices such as a suitably programmed microcontroller forming part of an apparatus for self-checkout and payment and in communication with at least one retailer server and one or more user devices, such as mobile phones, portable computers, tablet computers, or the like. The user devices are also typically in communication with a payment system which may comprise a computer system such as a server that is capable of processing payments made by the user and which may include a number of processing devices associated with each of an issuer, acquirer, card network and payment gateway. The payment system can include a point-of-sale (POS) device, and/or the payment system can include a digital wallet service.

In this example, at step 100 the one or more electronic processing devices of the apparatus for self-checkout and payment capture a signal containing information for at least one product. The signal can be either a wireless data signal or a visual indicia. The wireless data signal can be transmitted by RFID, while the visual indicia can be either a linear or a matrix barcode. The visual indicia can be captured by an image capturing apparatus. It should be noted that the information for the at least one product can include, for example, a price of the at least one product, an ID of the at least one product, expiry date of the at least one product and so forth.

At step 110, the information for the at least one product is extracted from the signal at the apparatus for self-checkout and payment. The extracted information is then transmitted to a retailer server and a user device. The retailer server is connected via a wireless data network, while the user device is connected or paired using a wireless data connection such as, for example, Bluetooth, Zigbee, Near Field Communications (NFC), Wi-fi and so forth. When the extracted information is transmitted to the retailer server, the retailer server can carry out tasks such as, for example, verifying the price of the at least one product, determine if there is an in-situ price variation for the at least one product, and so forth. The in-situ price variation can be dependent on a price determination algorithm which provides dynamic pricing for the at least one product. For example, the price determination algorithm can be dependent on expiry date of the at least one product, stock levels of the at least one product, seasonal demand for the at least one product, number of products being selected and so forth. The retailer server then provides a payment quantum for the at least one product based on the information for the at least one product.

At step 120, instructions are then received at the apparatus for self-checkout and payment to make payment to the retailer using a payment system. The instructions include initiating payment to the retailer at the payment system. It should be appreciated that the payment system can include, for example, one or more of a POS device, a payment portal, a digital wallet service, and so forth.

At step 130, there is verification by the retailer server that the requisite payment has been carried out. For example, after payment is carried out at the payment system, a receipt is generated at a user device which is connected/paired with the apparatus for self-checkout and payment. The receipt generated at the user device is configured to be verified by the retailer server to confirm that the requisite payment has been carried out to the appropriate retailer.

The above described method and apparatus provides a number of advantages.

Firstly, the method provide users with a convenient way of carrying out payments for desired products and services in a manner where a secure payment enablement option is at the side of the users, such that the users need not queue and wait for the payment facility.

Secondly, retailers are also able to dynamically update a payment quantum for their products for a variety of circumstances without having to update price tags on their products or store displays. It should be appreciated that the updating of payment quantums in the variety of circumstances can include, for example, dropping prices when at least a pre-determined number of the product is selected, dropping prices when nearing the expiry date of the product, maintaining prices when demand of the product is high, dropping prices when demand of the product is low, varying prices during festive periods, and so forth.

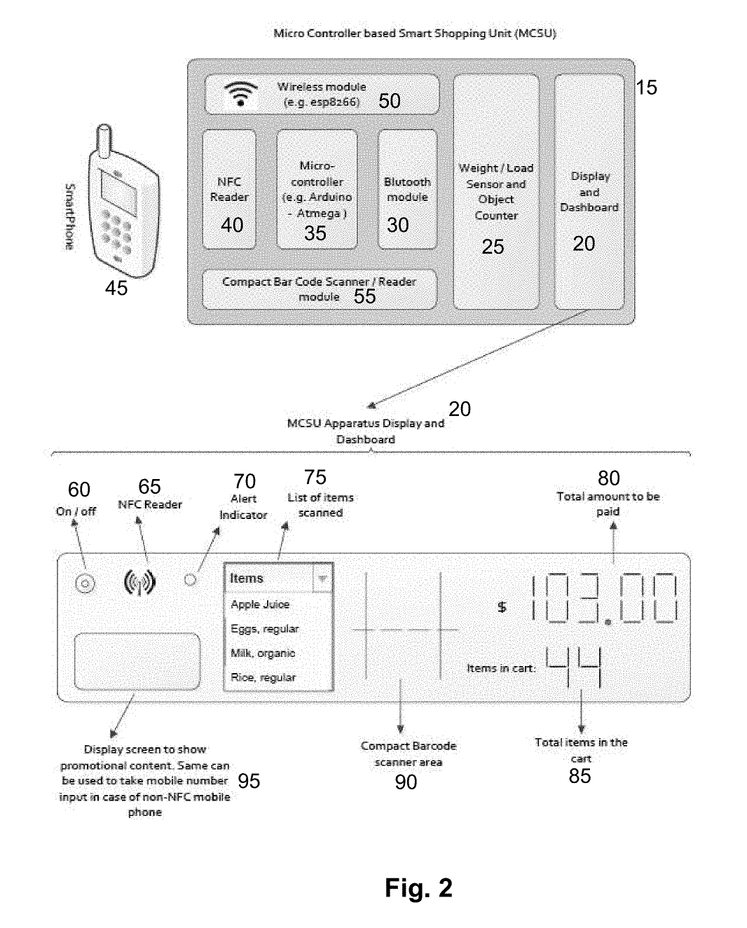

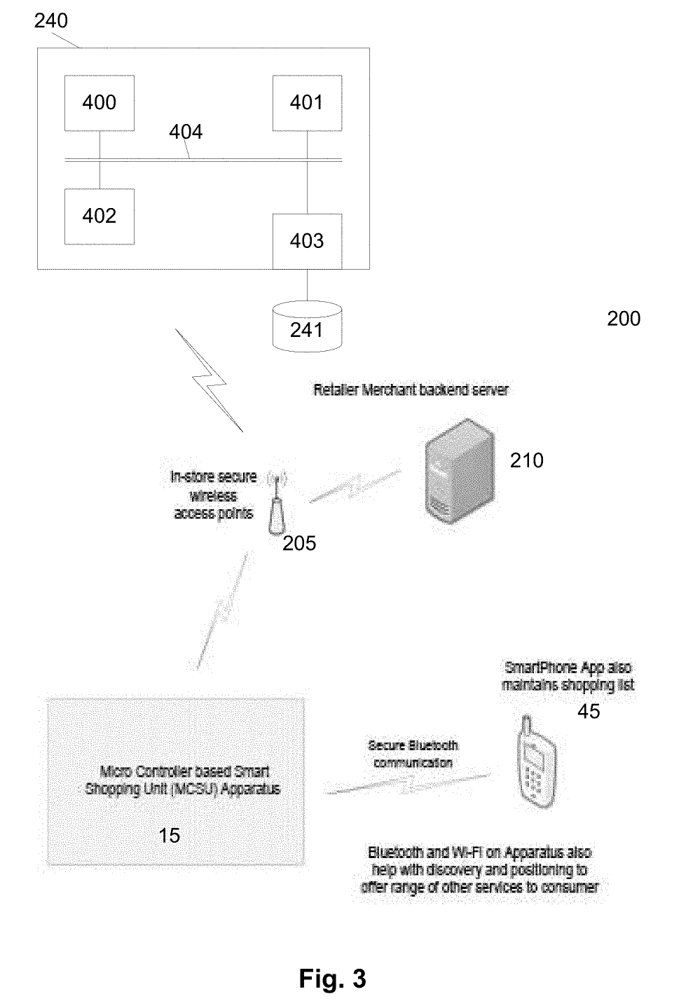

It is to be appreciated that the above described method is performed by one or more electronic processing devices forming part of an apparatus for self-checkout and payment. An example of the apparatus 15 for self-checkout and payment will now be described with reference to FIG. 2. The apparatus 15 can be integrated or retro-fitted with a conventional shopping trolley, typically at a handle of the conventional shopping trolley. In addition, the apparatus 15 is configured to interface with (pair) with a user device 45. Further details of the apparatus 15 will be provided in a subsequent section.

An example of a system 200 for self-checkout and payment will now be described with reference to FIG. 2.

In this example, the system 200 includes the apparatus for self-checkout and payment 15 in communication with a retailer server 210 and a payment system 240 via a wireless access point 205, and a user device 45 in communication with the apparatus 15. The user device 45 can be running a shopping application when in communication with the apparatus 15. The payment system 240 may be in communication with a database 241.

The wireless access point 205 is on a communications network of any appropriate form, such as the Internet and/or a number of local area networks (LANs). It will be appreciated that the configuration shown in FIG. 2 is for the purpose of example only, and in practice the user device 45, retailer server 210, and payment system 240 can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like. Typically, the user device 45 communicates with the apparatus 15 via a wireless communication protocol such as Bluetooth, Wi-Fi, Zigbee, or through Near Field Communication (NFC) but not limited to such. The apparatus 15 may typically communicate with the payment system 240 over a mobile network or via the Internet.

User Device 45

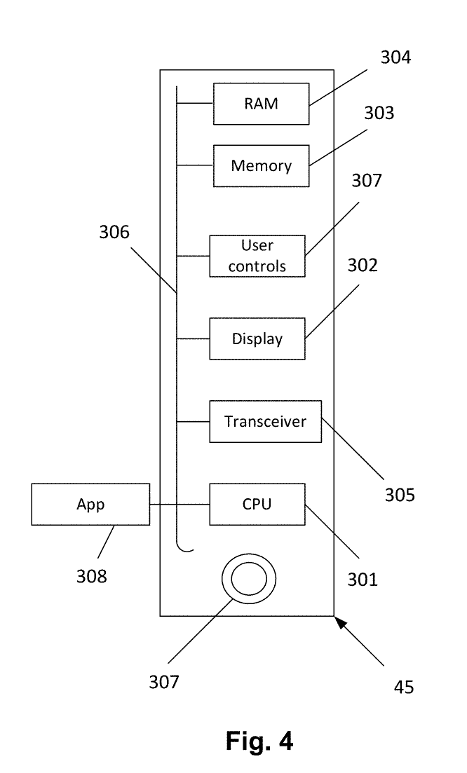

The user device 45 of any of the examples herein may be a handheld computer device such as a smart phone or a PDA such as one manufactured by Apple™, LG™, HTC™, Research In Motion™, or Motorola™. The user device 45 may include a mobile computer such as a tablet computer. An exemplary embodiment of a user device 45 is shown in FIG. 4. As shown, the device 45 includes the following components in electronic communication via a bus 306:
1. a display 302;
2. non-volatile memory 303;
3. random access memory (“RAM”) 304;
4. N processing components 301;
5. a transceiver component 305 that includes N transceivers; and
6. user controls 307.

Although the components depicted in FIG. 4 represent physical components, FIG. 4 is not intended to be a hardware diagram; thus many of the components depicted in FIG. 4 may be realized by common constructs or distributed among additional physical components. Moreover, it is certainly contemplated that other existing and yet-to-be developed physical components and architectures may be utilized to implement the functional components described with reference to FIG. 4.

The display 302 generally operates to provide a presentation of content to a user, and may be realized by any of a variety of displays (e.g., CRT, LCD, HDMI, micro-projector and OLED displays). And in general, the non-volatile memory 303 functions to store (e.g., persistently store) data and executable code including code that is associated with the functional components of a browser component and applications, and in one example, a shopping application 308 executing on the user device 45. In some embodiments, for example, the non-volatile memory 303 includes bootloader code, modem software, operating system code, file system code, and code to facilitate the implementation of one or more portions of the shopping application 308 as well as other components well known to those of ordinary skill in the art that are not depicted for simplicity.

In many implementations, the non-volatile memory 303 is realized by flash memory (e.g., NAND or ONENAND memory), but it is certainly contemplated that other memory types may be utilized as well. Although it may be possible to execute the code from the non-volatile memory 303, the executable code in the non-volatile memory 303 is typically loaded into RAM 304 and executed by one or more of the N processing components 301.

The N processing components 301 in connection with RAM 304 generally operate to execute the instructions stored in non-volatile memory 303 to effectuate the functional components. As one of ordinarily skill in the art will appreciate, the N processing components 301 may include a video processor, modem processor, DSP, graphics processing unit (GPU), and other processing components.

The transceiver component 305 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

Apparatus for Self-Checkout and Payment 15

Referring to FIG. 2, the apparatus 15 includes a microcontroller 35, a wireless WiFi module 50, an NFC reader 40, and a Bluetooth module 30. The microcontroller 35 communicates with the user device 45 via at least one of the aforementioned wireless modules 30, 40, 50, although it need not be limited to such and could include any suitable wireless transceiver. The microcontroller 35 can be configured to communicate with the user device 45 to transmit/retrieve data to/from the user device 45. The wireless WiFi module 50 can also be configured to enable the microcontroller 35 to communicate with remote servers on data networks, for example, retailer servers, in order to transmit/retrieve data to/from the remote servers. The apparatus 15 may further include local data storage although this is not shown. It should be appreciated that the type of data exchanged between the microcontroller 35 and the user device 45/remote server will be described further in a subsequent portion. Furthermore, the user device 45 can also be utilised to provide a location to the apparatus 15 to enable location-dependent services on the apparatus 15.

In addition, the apparatus 15 includes a bar code scanner 55 that can be configured to extract information from either a linear barcode or a matrix barcode. There is also a sensor-and-counter 25 to detect weight/number of objects placed in the shopping trolley and a display dashboard 20 for providing an indication of shopping being carried out. For example, the display dashboard 20 can include the following:

a power indicator 60 to indicate operational status;

an NFC reader status indicator 65 to indicate operational status of the NFC reader 40;

an alert indicator 70 to indicate any issues;

a first sub-display 75 to indicate the products placed in the shopping trolley;

a scanning area 90, through which enables an image capturing apparatus to capture an image of bar codes for the bar code scanner 55;

a second sub-display 95 to indicate promotional prices for scanned products;

a third sub-display 80 showing cumulative payment quantums for the products in the shopping trolley; and

a fourth sub-display 85 showing a result of the sensor-and-counter 25.

It is appreciated that typically, a power supply for the apparatus 15 is from a battery or other form of energy storage, whereby the battery or other form of energy storage undergoes charging when the shopping trolley that the apparatus 15 is integrated with is not in use.

In one example, a user (shopping) application 308 is provided on the user device 45 for use in interfacing with the apparatus 15. The shopping application 308 can be configured to facilitate the pairing of the user device 45 and the apparatus 15, and also to help a user to track and maintain a record of shopping when using the apparatus 15.

Payment System 240

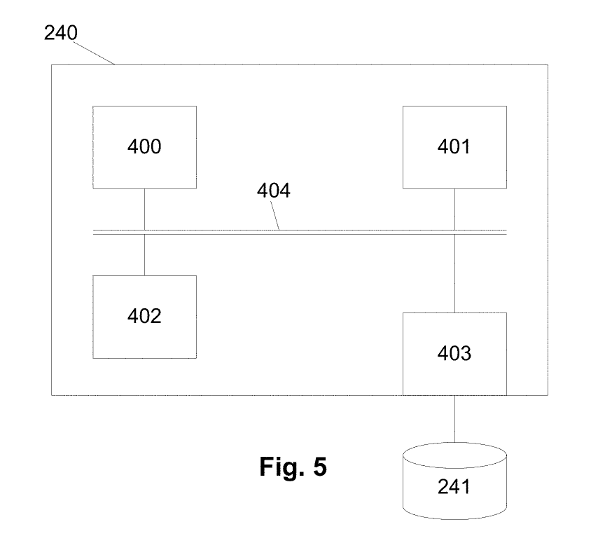

A suitable payment system 240 for use in the system described in anyone of the above examples is shown in FIG. 5.

In this example, the payment system 240 is a server that includes at least one microprocessor 400, a memory 401, an optional input/output device 402, such as a display, keyboard, touchscreen and the like, and an external interface 403, interconnected via a bus 404 as shown. In this example the external interface 403 can be utilised for connecting the payment server 410 to peripheral devices, such as the apparatus 15, the communication networks, databases 241, other storage devices, or the like. Although a single external interface 403 is shown, this is for the purpose of example only, and in practice multiple interfaces using various methods (e.g. Ethernet, serial, USB, wireless or the like) may be provided.

In use, the microprocessor 400 executes instructions in the form of applications software stored in the memory 401 to allow communication with the apparatus 15, for example, to receive instructions to initiate and make payment to the retailer. The applications software may include one or more software modules, and may be executed in a suitable execution environment, such as an operating system environment, or the like.

Accordingly, it will be appreciated that the payment system 240 may be formed from any suitable processing system, such as any electronic processing device, including a microprocessor, microchip processor, logic gate configuration, firmware optionally associated with implementing logic such as an FPGA (Field Programmable Gate Array), or any other electronic device, system or arrangement. However, the payment system 240 may also be formed from a suitably programmed PC, Internet terminal, lap-top, or hand-held PC, a tablet, or smart phone, or the like. Thus, in one example, the payment system 240 is a standard processing system such as an Intel Architecture based processing system, which executes software applications stored on non-volatile (e.g., hard disk) storage, although this is not essential.

In other examples, such as described above, the payment system 240 is formed of multiple computer systems interacting, for example, via a distributed network arrangement. As distributed networking is known in the art, it will not be described further in more detail.

In particular, the payment system may 240 include or be in communication with a number of processing systems associated with each of an issuer, acquirer, card network and payment gateway, or alternatively, the payment system may be any one or more of these entities.

In one example as will be well understood in the art, the payment system 240 sends the user account information and payment information to the merchant's acquirer. The acquirer then requests that the card network get an authorization from the user's issuing bank. The card network submits the transaction to the issuer for authorization and the issuing bank then authorizes the transaction if the account has sufficient funds to cover the amount payable. The issuer then routes payment to the acquirer who then deposits the payment into the merchant's account.

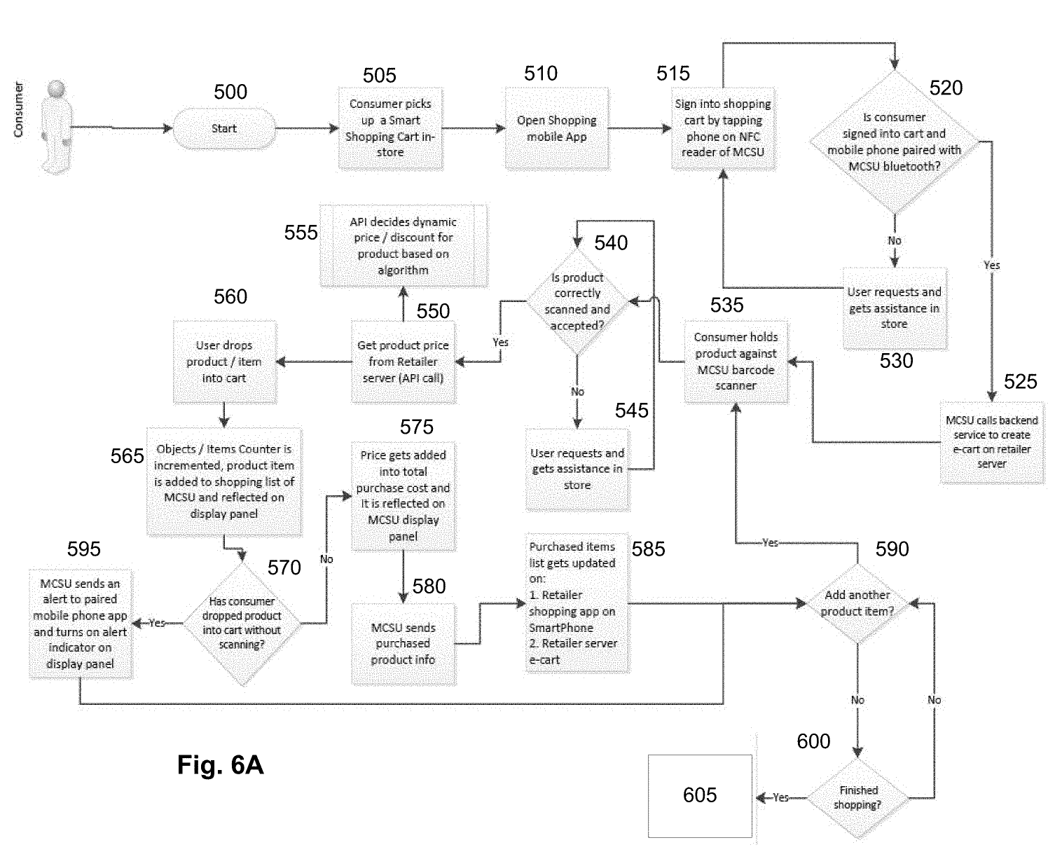

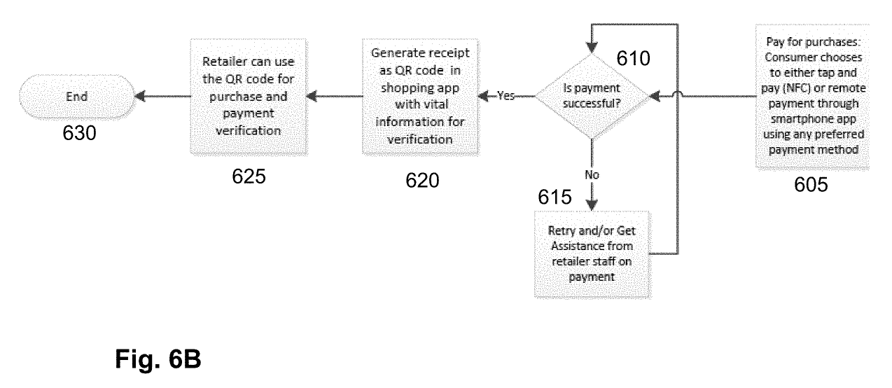

To illustrate further features of implementations of the method, a further detailed example of a method of self-checkout and payment will now be described with reference to FIGS. 6A and 6B.

From a starting step 500, a user gains access to a shopping trolley integrated with the apparatus 15 (as described earlier) at step 505, the apparatus 15 being integral with the shopping trolley or being retro-fitted to the shopping trolley.

At step 510, the user then accesses the shopping application 308 on the user device 45, and subsequently, at step 515, the user relies on, for example, NFC functionality of the user device 45 to turn on the apparatus 15. At step 520, the user device 45 and the apparatus 15 undergo pairing. If pairing is unsuccessful, the user seeks assistance at step 530.

If the pairing is successful, the apparatus 15 communicates with the retailer server 210 to create an e-cart on the retailer server 210 at step 525. Subsequently, at step 535, the user, for example, scans a visual indicia for a desired product at the apparatus 15, and at step 540, a determination is carried out at the apparatus 15 to ascertain if the visual indicia is appropriately scanned. If no, the user seeks assistance at step 545.

When the scanning of the visual indicia is appropriately carried out, a price (payment quantum) of the desired product is obtained from the retail server 210 at step 550. When obtaining the price of the desired product from the retail server 210, the retail server 210 also provides an in-situ price variation for the desired product at step 555. The in-situ price variation can be dependent on a price determination algorithm which provides dynamic pricing for the at least one product. For example, the price determination algorithm can be dependent on expiry date of the at least one product, stock levels of the at least one product, seasonal demand for the at least one product, number of products being selected and so forth. The in-situ price variation for the desired product can be shown, for example, at the second sub-display 95 of the apparatus 15. The retailer server 210 then provides a payment quantum for the at least one product based on the information for the at least one product.

At step 560, the user places the desired product into the shopping trolley, and at step 565, the object counter 25 of the apparatus 15 updates an object count for a number of items in the shopping trolley (for example, as shown in the fourth sub-display 85). At step 570, a determination is carried out whether the desired product missed scanning prior to placement in the shopping trolley. If yes, at step 595, a notification is indicated in the apparatus 15 (for example, at alert indicator 70) and an alert (for example, visual or audible) is also transmitted to the user device 15.

If no, at step 575, the price of the desired product is added to a total cost of products in the shopping trolley, and is indicated, for example, in the third sub-display 80 of the apparatus 15. Subsequently, at step 580, the apparatus 15 transmits details of the products in the shopping trolley. The details are received at the user device 45 and the retailer server 210 at step 585.

Following, a determination is made whether another product is desired at step 590. If yes, then step 535 occurs again. If no, a determination is made to confirm if no other product is desired at step 600. If no, then step 590 occurs again.

If yes, the user proceeds to make payment for the products in the shopping trolley at step 605 using, for example, a POS device, a payment portal, a digital wallet service, and so forth. Subsequently, a determination is made if the payment was successful at step 610. If no, another attempt is made to make payment for the products using, for example, a POS device, a payment portal, a digital wallet service, and so forth, or the user seeks assistance at step 615.

If yes, a receipt is generated in the shopping app 308 on the user device 45 at step 620, the receipt being configured to be verified by the retailer server 210 at step 625 to confirm that payment has been carried out. The receipt can be in the form of a QR code. The shopping process then ends at step 630.

Accordingly, it will be appreciated that in at least one example the above described methods and system provide users with a convenient way of carrying out payments for desired products and services in a manner where a secure payment enablement option is at the side of the users, such that the users need not queue and wait for the payment facility. In addition, retailers are also able to dynamically update a payment quantum for their products for a variety of circumstances without having to update price tags on their products or store displays. It should be appreciated that the updating of payment quantums in the variety of circumstances can include, for example, dropping prices when at least a pre-determined number of the product is selected, dropping prices when nearing the expiry date of the product, maintaining prices when demand of the product is high, dropping prices when demand of the product is low, varying prices during festive periods, and so forth.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1. A method for self-checkout and payment, the method including, in one or more electronic processing devices:
pairing a user device with a self-checkout apparatus;
capturing, at the self-checkout apparatus, a signal containing information for at least one product;
extracting, at the self-checkout apparatus, the information for at least one product;
receiving, from a retailer server, a payment quantum based on the information;
receiving, at the self-checkout apparatus, first instructions to make payment to a retailer using a payment system; and
initiating, at the payment system, the payment to the retailer.

2. The method of claim 1, further including, in one or more electronic processing devices:
transmitting, to the retailer server, the information for the at least one product;
transmitting, to the user device, the payment quantum; and
transmitting, to the user device, second instructions to generate a receipt at the user device.

3. The method of claim 1, wherein the pairing is via a wireless data connection, the wireless data connection being selected from a wireless communication protocol selected from: Bluetooth, Zigbee, NFC and Wi-fi.

4. The method of claim 1, wherein the signal is a wireless data signal, the wireless data signal being transmitted by RFID.

5. The method of claim 1, wherein the signal is a visual indicia, the visual indicia being either a linear barcode or a matrix barcode.

6. The method of claim 1, wherein the payment system comprises at least one of: a POS device, a payment portal and a digital wallet service.

7. The method of claim 2, wherein the receipt is configured to be verified by the retailer server to confirm that payment has been carried out.

8. The method of claim 1, wherein the payment quantum includes at least one in-situ payment quantum variation for the at least one product.

9. Apparatus for self-checkout and payment, the apparatus including one or more electronic processing devices that:
pairs a user device with the apparatus;
captures, with either an image capture apparatus or an RFID receiver, a signal containing information for at least one product;
extracts the information for at least one product;
receives, from a retailer server, a payment quantum based on the information;
receives, from the user device, first instructions to make payment to a retailer using a payment system; and
transmitting, to the payment system, initiation instructions for making payment to the retainer.

10. The apparatus of claim 9, further including one or more electronic processing devices that: transmits, to the retailer server, the information for the at least one product; and transmits, to the user device, second instructions to generate a receipt at the user device.

11. The apparatus of claim 9, wherein the pairing is via a wireless data connection, the wireless data connection being selected from a wireless communication protocol selected from: Bluetooth, Zigbee, NFC and Wi-fi.

12. The apparatus of claim 9, wherein the signal is a visual indicia, the indicia being either a linear barcode or a matrix barcode.

13. The apparatus of claim 9, wherein the payment system comprises at least one of: a POS device, a payment portal and a digital wallet service.

14. The apparatus of claim 10, wherein the receipt is configured to be verified by the retailer server to confirm that payment has been carried out.

15. The apparatus of claim 9, wherein the payment quantum includes at least one in-situ payment quantum variation for the at least one product.

16. A non-transitory computer readable storage medium embodying thereon a program of computer readable instructions which, when executed by one or more processors of an apparatus for self-checkout and payment in communication with at least one other server, cause the apparatus to perform self-checkout and payment, the method embodying the steps of:
pairing a user device with the apparatus;
capturing, with either an image capture apparatus or RFID receiver, a signal containing information for at least one product;
extracting the information for at least one product;
receiving, from a retailer server, a payment quantum based on the information;
receiving, from the user device, first instructions to make payment to a retailer using a payment system; and
transmitting, to the payment system, initiation instructions for making payment to the retainer.

17. The storage medium of claim 16, the method embodied further in the steps of:
transmitting, to the retailer server, the information for the at least one product; and
transmitting, to the user device, second instructions to generate a receipt at the user device.

18. The storage medium of claims 16, wherein the pairing is via a wireless data connection, the wireless data connection being selected from a wireless communication protocol selected from: Bluetooth, Zigbee, NFC and Wi-fi.

19. The storage medium of claim 16, wherein the signal is a visual indicia, the visual indicia being either a linear barcode or a matrix barcode.

20. The storage medium of claim 16, wherein the payment system comprises at least one of: a POS device, a payment portal and a digital wallet service.

21. The storage medium of claim 17, wherein the receipt is configured to be verified by the retailer server to confirm that payment has been carried out.

22. The storage medium of claims 16, wherein the payment quantum includes at least one in-situ payment quantum variation for the at least one product.
